(19) United States
(12) Patent Application Publication
(10) Pub. No.: US 2012/0117483 A1
(43) Pub. Date: May 10, 2012

(54) SYSTEM AND METHOD FOR DISTRIBUTING AND MANAGING MEDIA CONTENT ON MULTIPLE DEVICES

(75) Inventors: Jason Clement, San Diego, CA (US); Seth Hill, La Mesa, CA (US)

(73) Assignee: SONY CORPORATION

(21) Appl. No.: 13/043,746

(22) Filed: Mar. 9, 2011

Related U.S. Application Data
(60) Provisional application No. 61/411,205, filed on Nov. 8, 2010.

(51) Int. Cl. G06F 15/16; G06F 3/048

(52) U.S. Cl. 715/739; 709/219

(57) ABSTRACT

A method, system, and apparatus for a consumer electronics device that allows access to stored data, media files, and/or content on a remote storage device through a profile. A menu is then provided on the consumer electronics device that contains information relating to stored data, media files, and/or content located on the remote storage device, where the menu only relates to data, media files, and/or content capable of being presented on the consumer electronics device. Based at least on receiving a user's selection of a menu item, the consumer electronics device receives the data, media file, and/or content from the remote storage device for presentation on the consumer electronics device.

This claims priority from U.S. provisional application Ser. No. 61/411,205, filed Nov. 8, 2010.

### FIELD OF THE INVENTION

The present invention relates generally to managing and presenting data and media content on multiple consumer electronic devices.

### BACKGROUND OF THE INVENTION

Recent technological advances have provided for data and media content to be presented on a plurality of electronic devices, where particular types of data and media content were previously only cable of being presented on a single type of device. Currently, for example, television programs may not only be presented on televisions, but may now also be presented on personal computers, mobile tablet devices and mobile “smart phones.” Because of the above-recognized technological advances, users may own or have access to data and media content that they wish to have presented on multiple consumer electronics devices.

However, there is currently no relatively easy and secure way to accessing and presenting data and media content on multiple devices. Recognizing the above, the current application allows users to easily and securely access their data and content from multiple devices. Additionally, the current application allows access from multiple devices in an efficient, economical and eco-friendly way.

### SUMMARY OF THE INVENTION

A method may include initially prompting a user through a consumer electronics device to login to a profile managed over a network such as the internet, where the profile is associated with a remote storage device. The profile login information may only be required the first time the consumer electronics device attempts to access media files stored on the remote storage device and may not thereafter being required of the user to access the media files. The method may also include allowing access to stored media files on the remote storage device and then providing a menu on the consumer electronics device of stored media files located on the remote storage device. The menu may present media files capable of presentation on the consumer electronics device.

The method may further include, based at least on receiving a user's selection of a media file, receiving the media file from the remote storage device for presentation on the consumer electronics device. However, it is to be understood that, in some instances, more than one selection of media files may be received, where the plural selected media files may then be received from the remote storage device for simultaneous presentation on the consumer electronics device.

The method may also include determining media files to be provided on the menu by determining the characteristics of the consumer electronics device, and thereafter determining which media files on the remote storage device are capable of presentation on the consumer electronics device. A menu of content capable of presentation on the consumer electronics device may then be created based on at least one characteristic of the consumer electronics device. Additionally, the method may also include disassociating the consumer electronics device from the profile in some instances.

In another aspect, a content management system may include at least one consumer electronics device that has a processor, where the consumer electronics device may be capable of communication over the internet. The system may also include a remote storage device capable of storing media content, where the remote storage device may be accessible by the consumer electronics device. In non-limiting embodiments, the processor may be capable of receiving user login information and then using the login information to access a user profile over the internet, where the profile is associated with media content stored in the remote storage device. Because the processor may be programmed to receive user selection of media content stored in the remote storage device in non-limiting embodiments, the processor may present media content on the consumer electronics device in response to a selection.

In another aspect, an apparatus may include a consumer electronics device that has a processor, where the consumer electronics device is capable of communication over the internet. Additionally, in non-limiting embodiments, the consumer electronics device may communicate with a remote storage device over the internet. Furthermore, the remote storage device may be capable of storing media files, where the media files may be accessible by the consumer electronics device. Even further, the processor may receive a selection of a media file stored in the remote storage device in non-limiting embodiments and, in response to a selection, present the media file on the consumer electronics device.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting exemplary system in accordance with present principles;

FIG. 2 is a flow chart of non-limiting logic for presenting data and/or media files and/or content in accordance with present principles;

FIG. 3 is a flow chart of non-limiting logic for determining which data and/or media files and/or content associated with a profile are capable of being presented on the consumer electronics device in accordance with present principles;

FIG. 4 is a non-limiting, exemplary screenshot of a login prompt that may be received by a user in accordance with present principles; and

FIG. 5 is a non-limiting, exemplary screenshot of a menu of media files and/or content that may be presented on a consumer electronics device in accordance with present principles;

FIG. 6 is a non-limiting, exemplary screenshot of a menu of data that may be presented on a consumer electronics device in accordance with present principles;

FIG. 7 is a non-limiting, exemplary screenshot of a menu of data and media files and/or content that may be presented on a consumer electronics device in accordance with present principles;

FIG. 8 is a non-limiting, exemplary screenshot of a menu of links to other menus that may be presented on a consumer electronics device in accordance with present principles.

### DETAILED DESCRIPTION OF THE PREFERRED EMBODIMENT

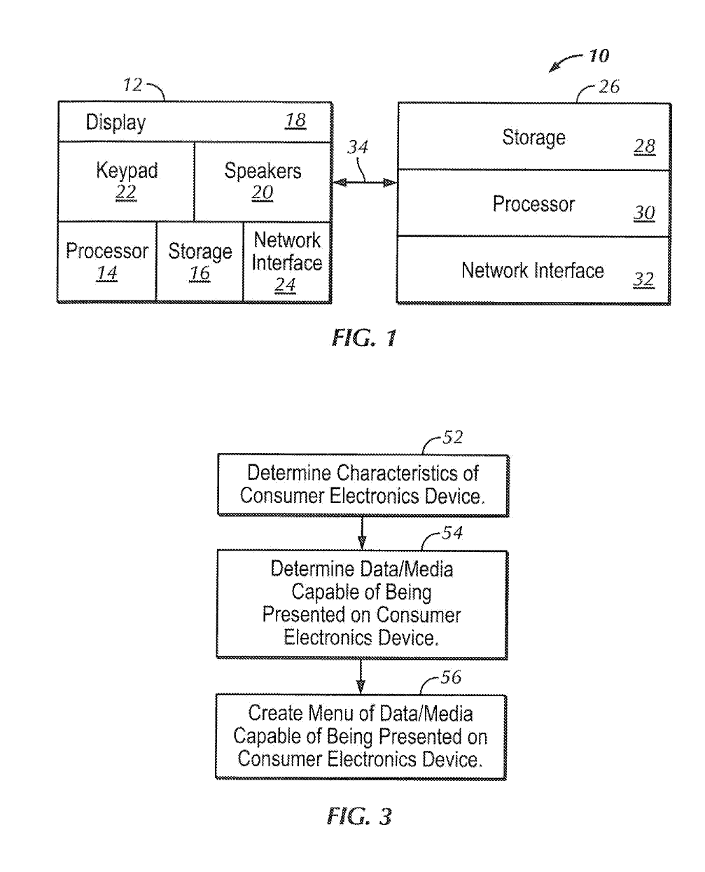

Referring initially to FIG. 1, a non-limiting, exemplary system generally designated 10 is shown. The system 10 includes a consumer electronics device 12, the consumer electronics device 12 having a processor 14 capable of executing logic such as the logic described below. The consumer electronics device 12 also includes one or more non-transitory computer readable data storage medium(s) 16 such as, but not limited to, RAM-based storage (e.g., a chip implementing dynamic random access memory (DRAM)) or flash memory or disk-based-storage. Moreover, logic, such as the logic described below, that is executable by the consumer electronics device 12 may be stored on the medium(s) 16 in accordance with present principles.

As shown in FIG. 1, the consumer electronics device 12 may also have one or more output devices such as a display 18 and speakers 20, the output devices being capable of presenting data and/or content such as audio and visual content to a user. The consumer electronics device 12 may also have one or more input devices capable of receiving input from a user, such as a keypad 22. However, it is to be understood that other input devices may also be present on the consumer electronics device 12, such as a personal computer “mouse” or a mobile telephone touch screen.

Additionally, the consumer electronics device 12 may include a network interface 24 such as a wired or wireless modem or wireless telephony transceiver that may communicate with the processor 14 to provide connectivity to a wide area network such as the internet. It is to be understood that the consumer electronics device 12 may also include a power supply (not shown) to provide voltage to the consumer electronics device 12, such as a battery or an AC/DC power supply.

Still in reference to FIG. 1, a remote storage device 26 is also shown. The remote storage device 26 has at least one non-transitory computer readable data storage medium 28 such as, but not limited to, RAM-based storage (e.g., a chip implementing dynamic random access memory (DRAM)) or flash memory or disk-based-storage. The storage medium 28 may be capable of storing profile information relating to at least one user, where the profile information may include login information and/or credentials that may be required to access data and/or media files and/or content. It is to be understood that the data and/or media files and/or content may also be stored on the storage medium 28 and associated with at least one profile.

Furthermore, it is to be understood that the terms “data,” “media content,” “media files,” and “content” as used herein are non-limiting terms that may refer to a plurality of electronic data types and formats. Those electronic data types and formats include, but are not limited to, textual data, MP3 and other audio formats, electronic games, picture formats, and video formats.

Additionally, the remote storage device 26 may also include a processor 30 capable of processing requests and/or commands received from the consumer electronics device 12 in accordance with present principles. The remote storage device 26 may also include a network interface 32, such as a wired or wireless modem or wireless telephony transceiver that may communicate with the processor 30 to provide connectivity to a wide area network such as the internet. Thus, the consumer electronics device 12 may communicate with the remote storage device 26 over the internet, as indicated by double arrows 34 shown in FIG. 1, which indicate network communication between the consumer electronics device 12 and remote storage device 26.

Now in reference to FIG. 2, a flow chart of non-limiting logic for presenting data and/or media files and/or content in accordance with present principles is shown. Beginning at block 36, a consumer electronics device substantially similar in function and configuration to the consumer electronics device 12 described above attempts to access data and/or media files and/or content on a remote storage device, where the remote storage device is substantially similar in function and configuration to the storage device 26 described above. It is to be understood that particular data and/or media files and/or content to which the consumer electronics device attempts to gain access may be associated with a particular user profile, and that the profile may be accessed from plural, functionally and/or physically different consumer electronics devices.

After the consumer electronics device attempts to gain access to media files on a remote storage device at block 36, the logic then proceeds to decision diamond 38. At decision diamond 38, the logic determines whether the consumer electronics device attempting to access data and/or media files and/or content on the remote storage device has previously logged in to and/or been previously associated with a particular user profile. If the logic determines that the consumer electronics device has not previously logged in to and/or previously been associated with a particular user profile associated with data and/or media files and/or content, the logic moves to block 40. At block 40, the logic prompts the user of the consumer electronics device to login to a profile, where the prompt may request particular login information, credentials, and/or profile information associated with the profile. At block 42 the logic receives the above-referenced user login information, credentials, and/or profile information and logs in and/or otherwise associates the consumer electronics device with the profile. The logic then proceeds to block 44.

However, before describing the process at block 44, reference is made back to decision diamond 38. If the logic determines that the consumer electronics device has previously logged in to and/or been previously associated with a particular user profile associated with data and/or media files and/or content, the logic proceeds directly to block 44 rather than to block 40. Regardless of whether the logic proceeds to directly block 44 from diamond 38 or first through blocks 40 and 42, the logic then allows the consumer electronics device access to stored data and/or media files and/or content on the remote storage device at block 44.

After the logic allows the consumer electronics device to access stored data and/or media files and/or content at block 44, the logic then proceeds to block 46 where a menu of data and/or media files and/or content capable of being presented on the consumer electronics device is presented on the consumer electronics device. The logic may then proceed to block 48, where the consumer electronics device receives user selection of a particular piece of data and/or particular media file and/or particular content provided on the menu for presentation on the consumer electronics device. However, it is to be understood that some devices may present plural pieces of data, media files, and/or content at the same time, and that a user may select multiple pieces of data, media files, and/or content from the menu for simultaneous presentation on the consumer electronics device in accordance with present principles. Concluding at block 50, the logic then presents the selected data and/or media files and/or content on the consumer electronics device.

Additionally, although the consumer electronics device may have been previously logged in to and/or been previously associated with a particular user profile in accordance with present principles, it is to be understood that in non-limiting embodiments, a particular profile previously associated with the consumer electronics device may be “logged out” of or otherwise disassociated with that profile. Another user profile may thereafter be associated with the consumer electronics device in accordance with present principles.

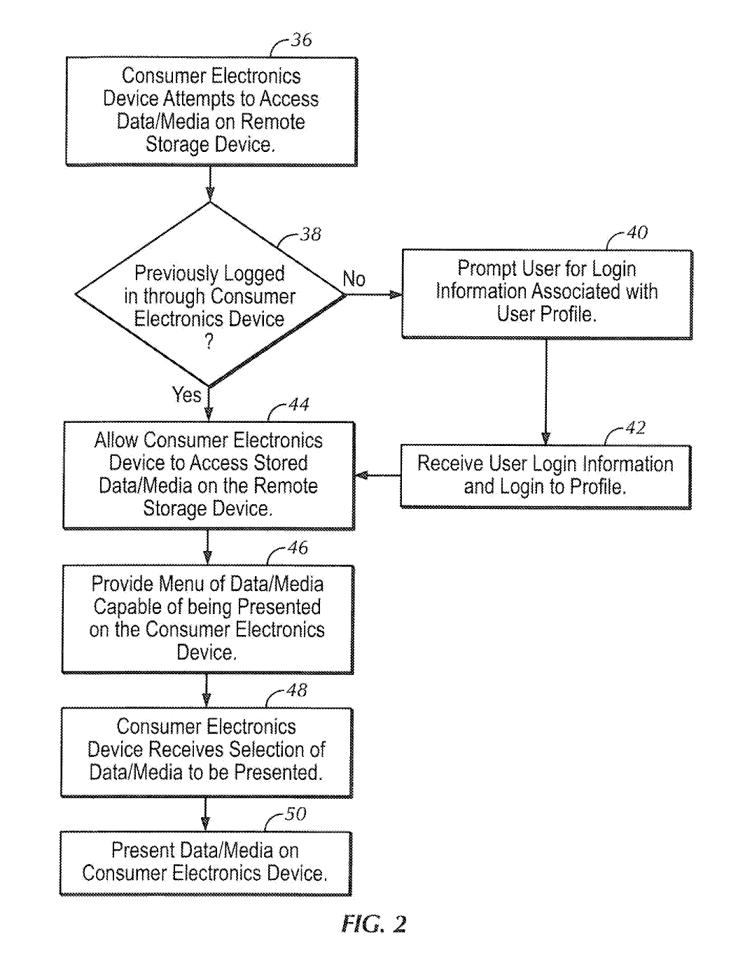

Now in reference to FIG. 3, a flow chart of non-limiting logic for determining which data and/or media files and/or content associated with a profile may be presented on the consumer electronics device in accordance with present principles is shown. Beginning at block 52, the logic determines the type and/or characteristics of the consumer electronics device that is accessing data and/or media files and/or content on a remote storage device through a profile, where the remote storage device is substantially similar in function and configuration to the remote storage device 26 referenced above. Still in reference to block 52, the logic may, for example, determine that the consumer electronics device is a mobile “smart phone” that is generally capable of presenting video content but is not capable of presenting content in a “widescreen” format. As another example, the logic may determine that the consumer electronics device is a television that has high-definition capabilities.

Still in reference to FIG. 3, the logic moves from block 52 to block 54. At block 54 the logic determines which data and/or media files and/or content associated with the profile being accessed is capable of being presented on the consumer electronics device. Concluding at block 56, the logic may create a menu or otherwise present available data and/or media files and/or content capable of being presented on the consumer electronics device.

In non-limiting embodiments, the menu may be created or presented through a technique referred to in the art as “auto-population,” where the data and/or media files and/or content capable of being presented is automatically uploaded to the consumer electronics device and/or organized in a menu format to the consumer electronics device. Thus, “auto-population” and as understood herein and in accordance with present principles may include either or both transferring the data and/or media files and/or content for storage on the consumer electronics device and separating and/or organizing available data and/or media files and/or content into electronic folders based on any number of characteristics (such as the type of media content, e.g., digital music and digital photographs).

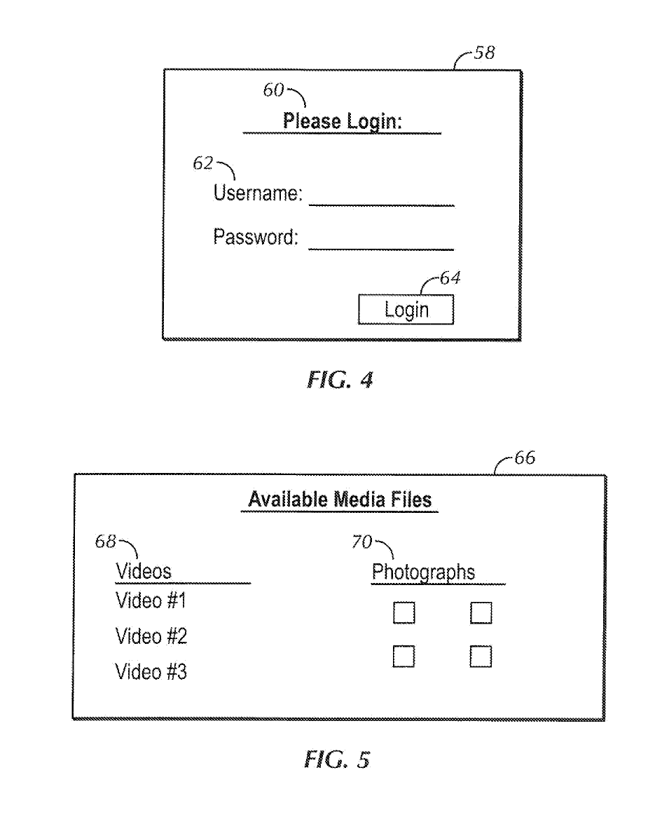

Now in reference to FIG. 4, a non-limiting, exemplary screenshot of a login prompt that may be presented to a user in accordance with present principles, e.g. at block 40 of FIG. 2 referenced above, is shown. It may be seen from FIG. 4 that the user of a consumer electronics device may receive a prompt for login information that is associated with a particular profile, the profile being associated data and/or media files and/or content on a remote storage device that the user wishes to access on the consumer electronics device.

Thus, the screen shot of FIG. 4 includes a prompt generally designated 58. As may be seen in FIG. 4, the prompt 58 may include textual instructions 60 that instruct a user to take a particular action, such as requesting that the user “login.” The prompt 58 may also include one or more input areas 62 for a user to enter required and/or requested information, such as a username and password associated with a particular profile. Such information may be entered by a user by using any number of available, non-limiting input devices associated with the particular consumer electronics device through which the user receives the prompt 58, such as the keypad 22 referenced above. FIG. 4 may further include a non-limiting button or “enter” key 64 for a user to select through a non-limiting input device, where the user selects the key 64 to login once the required and/or requested information is entered into the areas 62.

Moving on to FIG. 5, a non-limiting, exemplary screenshot of a menu of data and/or media files and/or content that may be presented on a consumer electronics device in accordance with present principles, e.g. at block 46 of FIG. 2 referenced above, is shown. Thus, it may be seen from the non-limiting presentation 66 of media files and/or content shown in FIG. 5 that the presentation 66 may include plural videos 68 and digital photographs 70 that may be selected for presentation on the consumer electronics device.

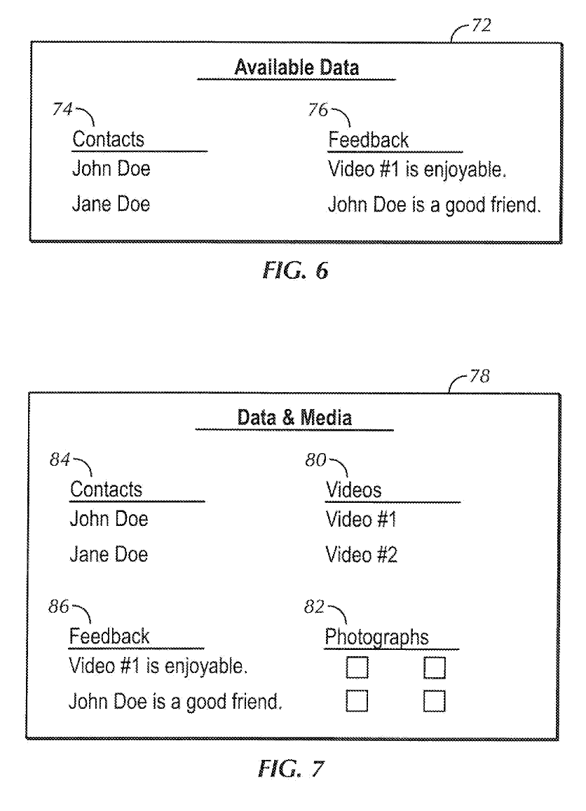

Now regarding FIG. 6, a non-limiting, exemplary screenshot of a menu of data, such as textual data that may be presented on a consumer electronics device in accordance with present principles e.g. at block 46 of FIG. 2 referenced above, is shown. Thus, it may be seen from the non-limiting presentation 72 of data in FIG. 6 that the presentation 72 may include plural personal contacts and/or contact information 74. In non-limiting embodiments, contacts may include friends of the consumer electronics device user. Also in non-limiting embodiments, contact information may include, information pertaining to, e.g., the contact's telephone number and home address.

Also in non-limiting embodiments, the presentation 72 of FIG. 6 may include feedback information 76. The feedback information 76 may include information pertaining and/or describing any number of things, including descriptions of data and/or media files and/or content. For example, the feedback information 76 may include information relating to a user's position or feeling regarding a particular video or how a user regards a contact provided under the contacts and/or contact information 74.

As yet another non-limiting alternative, a menu combining data with media files and/or content capable of selection in accordance with present principles may be presented. Thus, FIG. 7 shows a non-limiting, exemplary screenshot of data and/or media files and/or content that may be presented on a consumer electronics device. Thus, it may be seen from the non-limiting presentation 78 of data and/or media files and/or content in FIG. 7 that the presentation 78 may include plural videos 80, digital photographs 82, personal contacts and/or contact information 84, and/or feedback information 86. It is to be understood that, in non-limiting embodiments, the videos 80, digital photographs 82, personal contacts and/or contact information 84, and/or feedback information 86 may be substantially similar to the videos 68, digital photographs 70, personal contacts and/or contact information 74, and feedback information 76 described above.

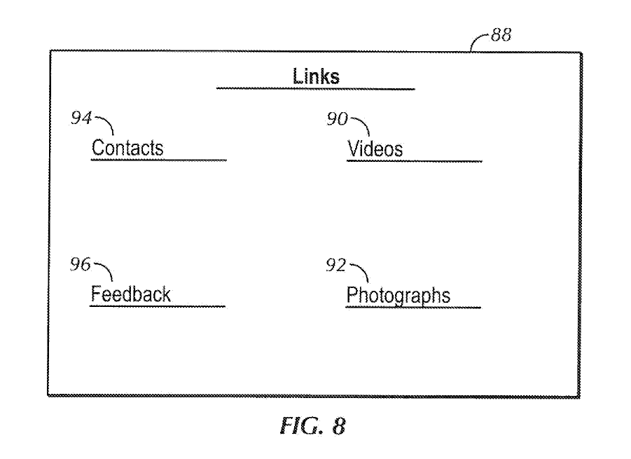

Even further, in other non-limiting embodiments, a menu of links to other menus relating to data and/or media files and/or content may be presented on a consumer electronics device. Thus, FIG. 8 is an exemplary screenshot of a menu of links to other menus that may be presented on a consumer electronics device, where the links are associated with types of data and/or media files and/or content in accordance with present. principles. Thus, FIG. 8 shows a non-limiting presentation 88 of links, where the presentation 88 may include a link 90 to a menu of videos, a link 92 to a menu of digital photographs, a link 94 to a menu of contact information, and/or a link 96 to a menu of feedback information.

Further, it is to be understood that upon selection of a link, such as one of the links shown in FIG. 8, a second presentation having a menu may thereafter be presented to the user of the consumer electronics device, where that presentation may contain a menu of any combination of data and/or media files and/or content available for selection by a user. E.g., in non-limiting embodiments, the second presentation may be substantially similar to the screen shots described in FIGS. 5-7 above.

While the particular SYSTEM. AND METHOD FOR DISTRIBUTING AND MANAGING MEDIA CONTENT ON MULTIPLE DEVICES is herein shown and described in detail, it is to be understood that the subject matter which is encompassed by the present invention is limited only by the claims.

What is claimed is:

1. A method, comprising:
initially prompting a user through a consumer electronics device to login to a profile managed over a network and associated with a remote storage device, the profile login information only being required a first time the consumer electronics device attempts to access media files stored on the remote storage device to access the media files and not thereafter being required of the user to access the media files;
allowing access to stored media files on the remote storage device;
providing a menu on the consumer electronics device of stored media files located on the remote storage device;
wherein the menu only presents media files capable of presentation on the consumer electronics device; and
based on at least receiving a user's selection of a media file, receiving the media file from the remote storage device for presentation on the consumer electronics device.

2. The method of claim 1, wherein determining media files to be provided on the menu comprises the steps of:
determining the characteristics of the consumer electronics device; and
thereafter determining which media files on the remote storage device are capable of presentation on the consumer electronics device.

3. The method of claim 2, further comprising creating a menu of content capable of presentation on the consumer electronics device based on the characteristics of the consumer electronics device.

4. The method of claim 1, wherein the network is the internet.

5. The method of claim 1, wherein plural selections of media files are received.

6. The method of claim 5, wherein plural media files are received from the remote storage device in response to the plural selections of the medial files for simultaneous presentation on the consumer electronics device.

7. The method of claim 1, further comprising disassociating the consumer electronics device with the profile.

8. A content management system, comprising:
at least one consumer electronics device including a processor, the consumer electronics device being capable of communication over the internet;
a remote storage device capable of storing media content and accessible by the at least one consumer electronics device;
wherein the processor is capable of receiving user login information;
wherein the processor uses the login information to access a user profile over the internet, the profile being associated with media content stored in the remote storage device;
wherein the processor is programmed to receive user selection of media content stored in the remote storage device and, responsive to a selection, presents the media content on the consumer electronics device.

9. The system of claim 8, wherein the consumer electronics device is a TV.

10. The system of claim 8, wherein the consumer electronics device is a mobile phone that includes a touch screen capable of receiving input.

11. The system of claim 8, wherein the consumer electronics device is a set-top box connected to a TV.

12. The system of claim 8, wherein upon receipt of user login information, the remote storage device sends media content to the consumer electronics device to be stored by the consumer electronics device.

13. The system of claim 8, wherein the media content includes digital music, digital photographs, and digital videos.

14. The system of claim 8, wherein the media content includes electronic games.

15. An apparatus, comprising:
a consumer electronics device including a processor, the consumer electronics device being capable of communication over the internet;
wherein the consumer electronics device communicates with a remote storage device over the internet, the remote storage device being capable of storing media files and the media files being accessible by the consumer electronics device;
wherein the processor receives selection of a media file stored in the remote storage device and, responsive to a selection, presents the media file on the consumer electronics device.

16. The apparatus of claim 15, wherein the consumer electronics device receives plural selections of media files.

17. The apparatus of claim 16, wherein the consumer electronics device receives plural media files from the remote storage device in response to the plural selections of the medial files and thereafter simultaneously presents the media files on the consumer electronics device.

18. The apparatus of claim 15, wherein the processor receives a selection of data stored on the remote storage device and, responsive to the selection, presents the data on the consumer electronics device.

19. The apparatus of claim 18, wherein the data includes contact information for individuals.

20. The apparatus of claim 18, wherein the data includes feedback information pertaining to the media files.
